(19) United States
(12) Patent Application Publication
(10) Pub. No.: US 2009/0302269 A1
(43) Pub. Date: Dec. 10, 2009

(54) Process and Composition for Controlling Foaming in Bulk Hydrogen Storage and Releasing Materials

(75) Inventors: Daiwon Choi, Richland, WA (US); Abhijeet J. Karkamkar, Richland, WA (US); S. Thomas Autrey, West Richland, WA (US); Christopher L. Aardahl, Richland, WA (US)

Correspondence Address: BATTELLE MEMORIAL INSTITUTE;ATTN: IP SERVICES, K1-53, P. O. BOX 999, RICHLAND, WA, 99352, US

(73) Assignee: BATTELLE MEMORIAL INSTITUTE, Richland, WA (US)

(21) Appl. No.: 12/477,040

(22) Filed: Jun. 2, 2009

Related U.S. Application Data
(60) Provisional application No. 61/059,573, filed on Jun. 6, 2008.

(51) Int. Cl. C01B 3/02; C09K 3/00

(52) U.S. Cl. 252/188.25

(57) ABSTRACT

New methods and compositions are disclosed that minimize foaming in hydrogen-releasing materials. Foaming can be minimized during release of hydrogen in composites that include structured forms such as wafers and discs. Change tolerances of from 0% to 25% in solid products described show promise for next-generation fuel elements and devices.

### CROSS REFERENCE TO RELATED APPLICATION

This application claims priority from Provisional application No. 61/059,573 filed 6 Jun. 2008, incorporated in its entirety herein by reference.

### STATEMENT OF GOVERNMENT SUPPORT

This invention was made with Government support under Contract DE-AC0576RLO-1830 awarded by the U.S. Department of Energy. The Government has certain rights in the invention.

### FIELD OF THE INVENTION

The present invention relates generally to anti-foaming compositions and processes. More particularly, the invention relates to a composition that includes a foam suppression reagent dispersed in a bulk hydrogen-releasing material and a method of making.

### BACKGROUND OF THE INVENTION

Hydrogen as a next-generation fuel of the future promises to provide higher energy density power sources for small power applications compared to conventional batteries, as well as energy security in addition to a clean-burning fuel for fuel-cell powered vehicles. Research groups around the world are investigating approaches to accelerate the discovery and development of hydrogen storage materials and systems. Such systems include components required to get hydrogen from a hydrogen fuel source to an end device or operating system, e.g., a fuel cell. However, rate, purity, and quantity of hydrogen released from these next-generation material compositions can be compromised by foaming that results in expansion of fuel element footprints or form factors. Changes in dimensions and/or form factors due to expansion of the fuel form upon hydrogen release can prove problematic for intended operating devices and applications. Weight considerations and space restrictions often doom conventional anti-foaming approaches and agents for uses in next-generation hydrogen storage and releasing fuels and devices. Accordingly, new compositions and methods are needed that prevent foaming in bulk hydrogen-releasing materials, especially solid materials where conventional anti-foaming agents designed for liquids do not work, that provide both suitable weight properties and volumetric footprints for space-limited applications in hydrogen fueled devices.

### SUMMARY OF THE INVENTION

In one aspect, the invention is a composition that controls foaming in hydrogen releasing materials. The composition includes: a preselected quantity of at least one foam suppression reagent; and a preselected quantity of least one hydrogen releasing material. The foam suppression reagent is dispersed in the at least one hydrogen releasing material or vice versa that yields a product that provides a preselected change tolerance upon release of hydrogen from the composite.

In one embodiment, the hydrogen releasing material includes ammonia borane.

In another embodiment, the hydrogen releasing material includes lithium borohydride.

In another embodiment, the hydrogen releasing material includes ammonia borane and lithium borohydride.

In various embodiments, the at least one foam suppression reagent can include a polymer: celluloses; starches; siloxane polymers; polyvinylalcohols; polyvinylidenes; polypyrroles; polylactones; polycarbonates; polystyrenes; polysaccharides; including combinations of these polymers.

In other embodiments, the at least one foam suppression reagent can include polysaccharides; oligosaccharides; disaccharides; monosaccharides; including combinations of these saccharides.

In yet other embodiments, the at least one foam suppression reagent can include: starches; celluloses; cellobioses; lignocelluloses; including combinations of these reagents.

Foam suppression reagents can further include: methyl cellulose; alkyl cellulose; acyl cellulose; xylitol; mannitol; and combinations thereof.

In yet other embodiments, foam suppression reagents can include organic acids selected from: citric acids; lauric acids; malonic acids; stearic acids; and combinations thereof.

In still yet other embodiments, foam suppression reagents can include: glycols; ureas; dextrins; paraffins; sorbitols; carbohydrates; and combinations thereof.

Foam suppression reagents can further include: siloxanes; polymethylsiloxanes; silanes; silicones; polyamino boranes; polyiminoboranes; and combinations of these reagents.

Foam suppression reagent can further include: celluloses; starches; siloxane polymers; and polyvinylalcohols.

In preferred embodiments, foam suppression reagents include: methyl cellulose; polyhydromethylsiloxane; sorbitol, and combinations thereof.

Foam suppression reagents have a preselected quantity in the composites selected in the range from about 1 wt % to about 50 wt %. Foam suppression reagents can also have a preselected quantity in the composites selected in the range from about 5 wt % to about 50 wt %. Foam suppression reagents can also have a preselected quantity in the composites selected in the range from about 10 wt % to about 30 wt %.

The composite product can be formed in a variety of shapes including, but not limited to, e.g., wafers, discs, tapes, monoliths, buttons, or other structured solid forms that do not crumble or lose their initial shape. In other embodiments, the composite product includes a structured form selected from: pellets, spheres, beads, particles, and combinations of these forms.

The product solid can further include a coating that facilitates release of hydrogen from the composition.

The solid product can also be dispersed in a solvent to form a slurry that facilitates transfer of the solid product, e.g., in a manufacturing facility.

The solid product can also include a catalyst to facilitate release of hydrogen from the composite.

In various compositions, the solid can have a change tolerance selected in the range from about 0% to about 10% by volume; or in the range from about 0% to about 25% by volume; or alternatively in the range from about 0% to about 100% by volume; or in the range from about 0% to about 200% by volume.

In other embodiments, the solid product can be used as a component of a stack device.

In other embodiments, the solid product can be affixed to a solid support. The solid support can be a porous solid support including, but not limited to, e.g., porous silica; porous titania; porous alumina; porous carbon; including combinations of these porous supports.

In another aspect, the invention includes a method of making a composite that includes at least one hydrogen releasing material and at least one foam suppression reagent. The method includes the steps of: dissolving a preselected quantity of the at least one hydrogen releasing material in a preselected solvent to form a solution; and dispersing a preselected quantity of the at least one foam suppression reagent therein to form a composite mixture. In the composite mixture, the at least one foam suppression reagent is dispersed in the at least one hydrogen releasing material or vice versa.

In one embodiment, the composite mixture is a slurry. In another embodiment, the composite mixture is a paste.

In another embodiment, the method further includes the step of removing the solvent from the composite product mixture to form a solid.

In one embodiment, the solid product is a powder product.

In another embodiment, the method includes the step of forming the solid product to yield a preselected shape for the product.

In one embodiment, the preselected shape for the product is a structure including, but not limited to, e.g., pencils, wafers, discs, tapes, monoliths, buttons, and combinations of these shapes. Other shapes include, but are not limited to, e.g., pellets, spheres, beads, particles, and combinations thereof. In various embodiments, the step of forming includes methods selected from: pressing, pelletizing, casting, extruding, mixing, coating, stirring, drying, and combinations of these methods. In various embodiments, the solid product can have a change tolerance selected in the range from about 0% to about 10% by volume upon release of hydrogen. In other embodiments, the solid product can have a change tolerance selected in the range from about 0% to about 25% by volume upon release of hydrogen therefrom. In still yet other embodiments, the solid product can have a change of from 0% to about 100% by volume upon release of hydrogen therefrom. In other embodiments, the solid product can have a change of from 0% to about 200% by volume upon release of hydrogen therefrom.

In another aspect, the invention includes a method for making a composite that includes at least one hydrogen releasing material and at least one foam suppression reagent. The method includes the steps of: mixing a preselected quantity of the at least one foam suppression reagent in a solvent to form a slurry; and dispersing a preselected quantity of the at least one hydrogen releasing material in the slurry, forming a composite mixture. In the composite mixture the at least one foam suppression reagent is dispersed in the at least one hydrogen releasing material or vice versa.

### BRIEF DESCRIPTION OF THE DRAWINGS

A more complete appreciation of the invention will be readily obtained by reference to the following description of the accompanying drawing in which like numerals in different figures represent the same structures or elements.

FIG. 1a is a top view of a structured (pressed) disc containing a neat bulk hydrogen releasing material, ammonia borane (AB), prior to heating.

FIG. 1b is a top view of a disc containing neat AB following heating.

FIG. 2 shows a proposed backbone structure of two foam suppression reagents tested in conjunction with the invention.

FIGS. 3a-3b show top views of two structured (pressed) discs of a (15% MC:85% AB) material composite (w/w) before and after heating, according to an embodiment of the invention.

FIG. 4 shows a top view of a structured (pressed) disc containing (10% MC:90% AB) material composite (w/w) showing controlled foaming following heating.

FIG. 5 shows a TGA plot for an 80 wt % ammonia borane:20 wt % methyl cellulose composition.

FIG. 6 shows a TGA plot for a 90 wt % ammonia borane:10% polymethylhydrosiloxane composition.

FIG. 7 shows an NMR plot showing peaks for spent hydrogen-releasing fuel compositions at various stages of hydrogen released.

### TERMS

The term “foaming” refers to the mechanisms and/or processes whereby gas introduced into the matrix of a hydrogen releasing material generates bubbles therein.

The term “foam” means the frothy material formed on, or in, a material as a result of gas or gas bubbles released unto the matrix of the material which causes the material to expand or change dimensions or exceed its initial footprint or boundaries, the extent of the expansion or dimension changes are determined by both the rate and quantity of gas introduced in the material.

The term “neat” means a hydrogen releasing material that does not include a foam suppression reagent or additive.

The term “connectedness” as used herein means the extent to which a neat hydrogen releasing material or fuel element expands or extends in the absence of a foam suppression reagent along any of its length (L), width (W), or height (H) dimensions including combinations of these dimensions. The extent of changes observed for a given composite material can be compared to changes observed for a neat material absent the control reagent or additive under identical experimental conditions. Methods for measuring connectedness include, but are not limited to, e.g., electron microscopy (e.g., scanning electron microscopy and transmission electron microscopy).

The term “wettability” as used herein means the ability of a solution containing a hydrogen releasing material, or a solvent alone, to wet, or achieve wetting of, the surface of a solid foam suppression reagent (additive) such that the solution or solvent liquid spreads over, adheres, and/or covers the surface of the solid. Ability of a solution containing a hydrogen releasing material in a solvent, or a solvent alone, to wet a surface of the solid can be a function of surface tension (or other energy properties), hydrophobicity or hydrophillicity of the liquid and solid, and/or the compatibility of the liquid and solid. The degree of wetting can be further manipulated by selection of functional groups of molecular constituents of the solid that increase the compatibility between the solution and solid, or that otherwise minimize differences between the solution and the surface of the solid, as described further herein.

The symbol (Mn) listed herein means “molar mass” of a selected constituent (n) in units of grams per mole (g/moL).

### DETAILED DESCRIPTION OF THE INVENTION

The present invention includes new compositions and new methods that minimize foaming in bulk hydrogen storage and releasing materials as the materials release hydrogen. The invention prevents foaming without altering the chemistry and performance of the bulk hydrogen storage and releasing material. The invention encompasses devices and applications that utilize the invention composition and method. Exemplary foam suppression reagents and additives are described that prevent or significantly reduce foaming in bulk hydrogen storage and releasing materials that undergo transitions such as melting and dehydrogenation that release free hydrogen from the releasing materials. While the present invention is described herein with reference to the preferred embodiments thereof, it should be understood that the invention is not limited thereto, and various alternatives in form and detail may be made therein without departing from the scope of the invention. For example, ammonia borane (NH₃BH₃), denoted herein as (AB), is an exemplary and representative hydrogen releasing fuel material tested in conjunction with the invention. However, the invention is not limited thereto. This and other hydrogen storage and releasing materials are described, e.g., in U.S. Pat. No. 7,316,788 issued 8 Jan. 2008; U.S. application Ser. No. 11/941,549 filed 16 Nov. 2007 published as Publication Number 2008-0112883 on 15 May 2008; and U.S. application Ser. No. 12/435,268 filed 4 May 2009, which references are incorporated herein in their entirety by reference. All hydrogen storage and releasing materials as will be selected and envisioned by those of skill in the art in view of the disclosure are within the scope of the invention. No limitations are intended.

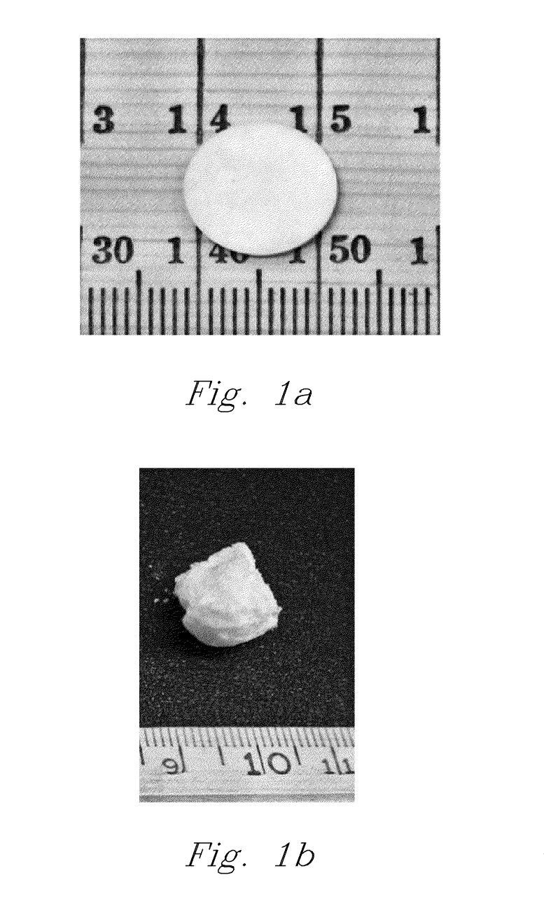

Foaming can occur in hydrogen releasing materials that undergo a phase change (e.g., melting) or dehydrogenation that releases free hydrogen. For example, ammonia borane (NH₃BH₃) (AB) and lithium borohydride (LiBH₄), and other hydrogen releasing materials, can foam extensively as they liberate hydrogen gas. Release of hydrogen (dehydrogenation), however, does not always accompany a phase change. For example, physical changes including, but not limited to, e.g., melting, vaporization, sublimation, foaming, and other physical changes in the properties of a material can inhibit the rate of hydrogen release, or may result in localized foaming where any released hydrogen gives rise to expansion of the material. Hydrogen releasing materials can form a connected shell or covering that traps hydrogen bubbles during hydrogen release from the material. As hydrogen gas escapes from the highly viscous, plastic material, rupture from the shell or covering results in foaming which appears as localized foaming zones or cells. These foaming zones or cells are composed primarily of the polymeric compounds of the hydrogen releasing materials that now are hydrogen depleted. FIG. 1a shows a top view of a structured (pressed) disc (coupon) containing an exemplary neat bulk hydrogen releasing material, ammonia borane (AB), prior to heating. In the figure, the AB coupon is compact and has preselected dimensions. FIG. 1b shows the foaming behavior of neat ammonia borane (AB) following heating. When heated in the solid state or as a slurry in solution, at temperatures in the range from about 60° C. to about 250° C., in the absence of a suitable foam suppression reagent or additive, ammonia borane (AB) undergoes a dramatic change in volume as it liberates hydrogen. The solid expands and extends in all dimensions, ultimately forming a solid with a voluminous and spongy appearance.

In the present invention, addition of a selected foam suppression reagent(s) or additive(s) to the hydrogen releasing material has been shown to disturb the ability of hydrogen releasing fuel materials to form zones of bubbles or to generate foaming zones of unusable material. Ability to disrupt the formation of these bubbling zones facilitates release of usable hydrogen from the releasing material. In particular, gas volume from disrupted cells allows other spherical gas spaces to be broken, which limits growth of bubbles in the matrix of the releasing material. Further, if the ability to form a foaming connectedness (mass) is disrupted, the degree of foaming observed during release of hydrogen from the bulk hydrogen releasing fuel material is substantially reduced. In particular, in the presence of a suitable foam suppression reagent or additive, bulk hydrogen releasing materials have shown a dramatic decrease in both the degree and amount of foaming. Such additives alter properties of the hydrogen releasing material, e.g., surface tension, and thereby minimize foaming. Addition of these reagents to the hydrogen releasing material (e.g., by solid state mixing or solution based approaches) has thus proven advantageous. Other additives and/or catalysts can also be added to enhance release (or other) properties of the hydrogen releasing materials.

### Foam Suppression Reagents

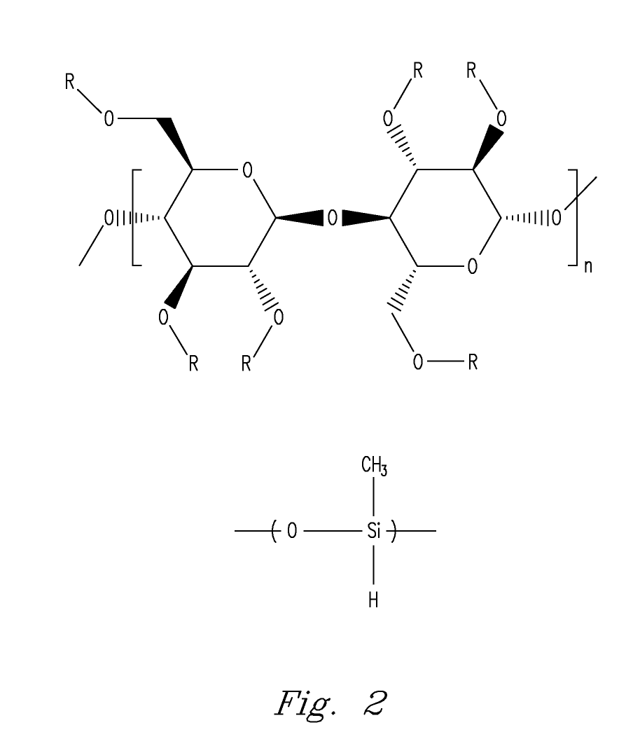

Foam suppression reagents (additives) suitable for use in conjunction with composites of the invention containing hydrogen releasing materials include, but are not limited to, e.g., carbohydrates including, e.g., saccharides (e.g., monosaccharides, disaccharides, oligosaccharides, and other saccharides); polysaccharides (e.g., starches, celluloses, cellobioses, lignocelluloses, and other polysaccharides); polymers (e.g., siloxanes, polymethylsiloxanes, silanes, silicones, polyamino boranes, polyiminoboranes, and other polymers), and like reagents, including combinations of these reagents. Preferred foam suppression agents have at least one functional group including, but not limited to, e.g., acyl, alkyl, acryl, ethyl, methyl, alkoxy, hydroxyl, hydroxymethyl, carboxyl, carbonyl, butyl, propyl, vinyl, phenyl, halogens, and like functional groups, including combinations of these functional groups that when mixed or combined with a hydrogen storage material in a solvent have the ability to wet the surface of the solid foam suppression agent thereby dispersing or coating the surface of the foam suppression agent with the hydrogen storage material. Preferred foam suppression agents further do not chemically alter the hydrogen storage and releasing material. They do not chemically react with the hydrogen storage and releasing materials. FIG. 2 shows the backbone structure of two exemplary foam suppression reagents tested in conjunction with the invention, i.e., methyl cellulose (MC) [CAS# 9004-67-5] (Mₙ=17000-86000); and polyhydromethylsiloxane (PHMS) [CAS# 9004-73-3]. Another exemplary foam suppression reagent tested in conjunction includes sorbitol [CAS#: 50-70-4] (M_{w}=186). Other foam suppression reagents include, but are not limited to, e.g., methyl cellulose (MC) (Mₙ=10000-120000), alkyl cellulose, acyl cellulose, xylitol, and mannitol. Molecular weights of foam suppression reagents (additives) are selected in the range from about 300 g/mol to about 300,000 g/mol. In other embodiments, foam suppression reagents have molecular weights selected in the range from about 300 g/mol to about 100,000 g/mol. In yet other embodiments, foam suppression reagents have molecular weights selected in the range from about 360 g/mol to about 86,000 g/mol.

### Compositions

Composites of the invention incorporate a preselected quantity of at least one foam suppression reagent (additive) and at least one hydrogen releasing material prepared using selected solvents described further herein. Compositions include at least one foam suppression reagent (additive) in the range from about 1 wt % to about 50 wt %; or in the range from about 5 wt % to about 50 wt %. A preferred quantity of the at least one foam suppression reagent (additive) is selected in range from about 10 wt % to about 30 wt %.

### Preparation of Composites

Dissolution of the hydrogen releasing material in a solvent to form a solution, followed by subsequent wetting of the foam suppression reagent is a preferred method for preparation of the composite material, but is not limited thereto. For example, composite materials can be alternatively prepared by adding a hydrogen releasing material to a solvent solution containing a wetted (non-dissolved) foam suppression agent. Alternatively, the foam suppression agent can be added to a (solvent) solution containing a dissolved hydrogen releasing material. Alternatively, a hydrogen releasing material dissolved in a solvent can be added to a foam suppression reagent wetted in a like or different solvent can be mixed together. Alternatively, a hydrogen releasing material can be melted and used to wet a foam suppression reagent in the absence of a solvent. Alternatively, a foam suppression reagent can be mixed as a slurry in a preselected solvent with a hydrogen releasing material or the multiple components can be mixed in dry form. Proper dispersion of the foam suppression reagent in the hydrogen releasing material can be achieved in the melting or solution steps by incorporation of the hydrogen releasing material into the highly porous matrix of the foam suppression reagent. Despite its relatively small proportion in the composite, the foam suppression additive demonstrates sufficient dispersion with the hydrogen releasing material so as to effectively encapsulate small quantities of the hydrogen releasing material (e.g., ammonia borane) in the composite material. When properly wetted, the foam suppression reagent (FSA) is well dispersed with the hydrogen storage and releasing material in the composite. Removal of the solvent forms the solid product composition. Structured forms for the fuel element compositions include, but are not limited to, e.g., disks, monoliths, pellets, wafers, and like structures. The solid can be prepared in various forms including, but not limited to, e.g., pellets, discs, wafers, monoliths, buttons, and like solid forms. Pressing (e.g., using a solid pellet press) is a preferred method for preparing these exemplary solid forms, but is not limited thereto. In other embodiments, tapes of the solid composite materials can be prepared using, e.g., various casting (e.g., tape casting) and masking techniques known in the art. Solid composite materials prepared in these various structured forms permit a variety of fuel elements to be constructed containing the foam suppression reagent (additive) and the bulk hydrogen releasing material. In a properly constructed structured form, the fuel element does not crumble or lose its initially formed shape. Composite solids can also be utilized, e.g., in various dispersed forms including, e.g., slurries in various solvents as will be understood by those of skill in the art. Thus, no limitations are intended. Preparation methods will depend in part on the scale or quantity of the composite materials to be prepared for intended applications. All flow paths for preparation of the materials of the invention as will be selected by those of ordinary skill in the art in view of the disclosure of within the scope of the invention. Thus, no limitations are intended.

### Solvents

Composites of the invention are prepared using selected solvents. Solvent selection depends on the solubility of the hydrogen releasing material in the selected solvent and the ability to wet (wettability) the selected foam suppression reagent. Preferred solvents dissolve the selected hydrogen releasing material to form a solution. Prepared solutions can then be used to wet the foam suppression reagent. Preferred solvents for preparing hydrogen releasing material and foam suppression reagent compositions include, but are not limited to, e.g., water, tetrahydrofuran, ether, glyme, diglyme, tetraglyme, and like solvents. Other solvents that may be suitable for use in conjunction with the process include hydrocarbon solvents, e.g., alkanes (pentane, hexane, etc.) and aromatic solvents including, e.g., toluene, benzene, xylene, and like solvents. While selected solvents are described herein in reference to preferred embodiments, the invention is not limited thereto. All solvents as will be selected by those of skill in the art in view of the disclosure are within the scope of the invention. No limitations are intended

### Foam Suppression

Ability of a foam suppression reagent (additive) to suppress foaming in a composite material containing a hydrogen releasing material depends on the ability of the reagent to integrate with, or otherwise disperse in, the hydrogen releasing material or the matrix of the composite. Ability of the reagent or additive to integrate with the hydrogen releasing material depends on the degree to which the surface of the foam suppression reagent or additive is wetted by the solution containing the hydrogen releasing material or an appropriate solvent. The foam suppression reagent, when dispersed in the hydrogen releasing material, is presumed to provide localized zones or pockets of hydrogen releasing material in sufficiently close proximity to a quantity of foam suppression reagent that qualifies or facilitates the release of hydrogen from the zones or pockets. The close proximity of the foam suppression additive to the hydrogen releasing materials in the composite serves to alter the size of gas bubbles or the foaming behavior of gas bubbles at the surface of the composite material thereby changing the extent of foaming upon hydrogen release. When hydrogen is subsequently released from the hydrogen releasing material, effectively disrupts the ability of the hydrogen releasing material to form gas bubbles in the matrix of the composite material, i.e., it limits the size and the extent of gas bubble formation therein. A key to controlling foaming in the composite material is related to the wettability or the ability to maximize wetting of the foam suppression reagent (additive) with the solution containing the hydrogen releasing material. Wettability of the solid foam suppression reagent appears to facilitate the dispersal of hydrogen releasing material in the composite material. Dispersal of the hydrogen releasing material in the composite is facilitated by the ability of a solution containing the hydrogen releasing material, or a solvent alone, to wet, or achieve wetting of, the surface of a solid foam suppression reagent (additive) by allowing the solution or solvent liquid to spread over, adhere, or otherwise cover the surface of the solid. Ability of the solution containing the hydrogen releasing material to wet the surface of the foam suppression agent can also be a function of surface tension (or other energy properties), hydrophobicity or hydrophillicity of the liquid and solid, and/or the compatibility of the liquid and solid. Hydrophobicity or hydrophillicity of the solution and/or solvent with the foam suppression solid of interest is governed by functional groups present in the molecular make-up of the solid of interest and their compatibility with the solution or solvent, as described previously herein. Degree of wetting can be further manipulated by selection of functional groups or molecular constituents of the solid that increase the compatibility between the solution and solid, or that otherwise minimize differences between the solution and the surface of the solid. TABLE 1 lists foaming results obtained for composites made from an exemplary bulk hydrogen releasing material, ammonia borane, and exemplary foam suppression reagents in concert with the invention.

Table 1 lists exemplary compositions for composite materials that include a selected foam control reagent and a bulk hydrogen releasing material, ammonia borane (AB), that show foam suppression qualities.

| | Quantity | Foaming |
|---|---|---|
| FOAM SUPPRESSION ADDITIVE | (Wt %) | (Y or N) |
| Methyl cellulose | 5-20 | N |
| (Mn = 17000 | | |
| Methyl cellulose | 5-20 | N |
| (Mn = 86000) | | |
| Polymethylsiloxane (PMHS) | 30 | N |
| Sorbitol | 15 | N |

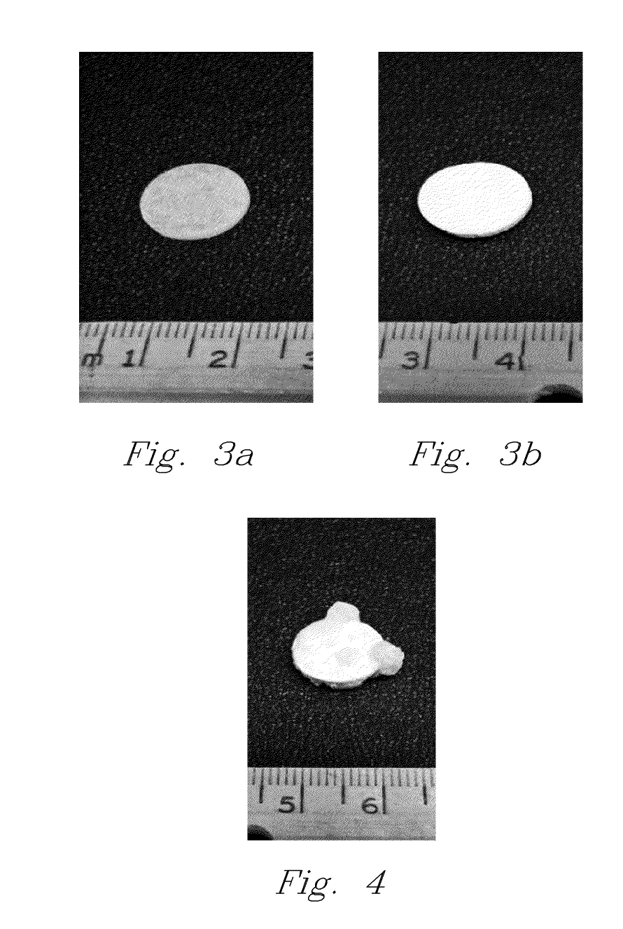

These foam suppression reagents form microsized porous scaffolds when mixed with a hydrogen releasing material in a suitable solvent that achieve a mechanical strength sufficient to hinder foam growth during hydrogen release. Extent of foaming is difficult to characterize or measure because foaming materials become porous and brittle, typically falling apart on contact with measuring instruments. However, results demonstrate that suitable quantities of selected foaming control reagents adequately control foaming of the solid composite, permitting release of hydrogen from the hydrogen releasing material while stabilizing the melt which transforms the solid. FIG. 3a is a top view of a structured (pressed) disc containing a material composite that includes 15% methyl cellulose (MC) and 85% ammonia borane (AB) (w/w) before heating. FIG. 3b shows a pressed disc containing a material composite that includes 15% methyl cellulose (MC) and 85% ammonia borane (AB) (w/w) after heating. In the figure, no foaming is evident. The footprint and dimensions of the disc are identical to those of the initially formed composite. FIG. 4 is a top view of a pressed disc containing a material composite that includes 10% (MC) and 90% (AB) (w/w). In the figure, foaming in the composite is only about 1% to about 5% of that observed for the neat hydrogen releasing material (AB) following heating. Localized foaming may be further controlled by optimizing the mixing and dispersion of the components in the composite. Results demonstrate that composites can be made that exhibit excellent temperature stability during chemical changes resulting from hydrogen release during heating at temperatures greater than about 200° C.

### Foam Expansion Tolerances for Composites

Composites of the invention can be prepared that achieve preselected foaming change tolerances or volumes for intended applications (e.g., as fuel elements) that maintain footprints and dimensions for prepared solid materials described herein. Tolerances are based on recipes developed from experiments that look at ratios of selected foam suppression reagents to hydrogen releasing materials for a selected composite. For example, in some applications and devices, foaming extension tolerances may be restricted in the range from 0% to about 10% by volume (e.g., 1 cm³ to ≦1.1 cm³; or 1 m³ to ≦1.1 m³; or 1 L to ≦1.1 L). In other applications, tolerances may be selected in the range from about 0% to about 25% by volume (e.g., 1 cm³ to ≦1.25 cm³; or 1 m³ to ≦1.25 m³; or 1 L to ≦1.25 L). In other applications, tolerances may be selected in the range from about 0% to about 100% by volume (e.g., 1 cm³ to ≦2 cm³; or 1 m³ to ≦2 m³; or 1 L to ≦2 L). In yet other applications, tolerances may be selected in the range from about 0% to about 200% by volume (e.g., 1 cm³ to ≦3 cm³; or 1 m³ to ≦3 m³; or 1 L to ≦3 L, and etc.). Composites of the invention can be tailored to achieve various tolerances for intended applications and devices. In contrast, conventional hydrogen releasing materials that do not contain a suitable foaming suppression reagent or additive can expand uncontrollably. In an exemplary baseline test, untreated ammonia borane (AB) expanded by as much as 4000% compared to composites that included methyl cellulose.

### APPLICATIONS

Compositions and composites of the invention containing hydrogen releasing materials and foam suppression reagents (additives) are expected to find uses in fuel elements; light-duty energy appliances and devices including, but not limited to, e.g., solid oxide fuel cells (SOFCs); Polymer Electrolyte Membrane (PEM) fuel cells (PEMFCs); energy sources for appliances including, but not limited to, e.g., computers (e.g., laptop computers); hand-held devices (e.g., cell phones, palm-pilots, and like devices); audio devices (e.g., radios, mp3 players, satellite radios, and like devices); automobile accessory devices (e.g., fans, sunroofs, dome lights, displays, radios, GPS units, air conditioning, and like devices); large-scale devices (e.g., backup power units for home, transportation, and like devices and power applications. Ultimately such devices will power automobiles and vehicles in various transportation applications and systems.

### EXAMPLES

Foaming behavior of various compositions was tested. Compositions included a preselected ratio of at least one foam suppression reagent and at least one bulk hydrogen releasing material, i.e., ammonia borane (AB). While ammonia borane is described, its use is exemplary of many hydrogen storage and releasing materials. Thus, the invention is not limited thereto. Each composition was then compared with the foaming behavior of the native hydrogen releasing material (i.e., no foam suppression agent). In exemplary tests, methyl cellulose and polyhydromethylsiloxane (PHMS) were used as foam suppression reagents (FSA). Each reagent was mixed with a solution containing ammonia borane (AB) as the exemplary hydrogen releasing material dissolved in tetrahydrofuran solvent. Solid wafers were formed and tested that included from about 1 wt % [FSA:AB] to about 30 wt % [FSA:AB] of the composite material (w/w). Typical wafers were 12 mm across, had a thickness of 3 mm, and included 100 mg of the composite material, but are not limited thereto. The following examples are presented.

### Example 1

### Preparation of MC:AB Composite

### 20 wt %:80 wt %

In an exemplary test, 0.800 g of ammonia borane (AB) solid was dissolved in 5 mL of tetrahydrofuran (THF). 0.200 g of methyl cellulose (MC) (Mₙ=86000) powder was added to the AB/THF solution. The mixture was well dispersed using a spatula to obtain a smooth pasty mixture. Solvent (THF) was evaporated from the pasty mixture to obtain a dry powder. The material was held under vacuum conditions to ensure complete removal of the solvent. The composite material contained 20% methyl cellulose (MC) and 80% ammonia borane (AB) by weight (wt %).

### Example 2

### DSC/TG Tests

### MC:AB Composite

### 20 wt %:80 wt %

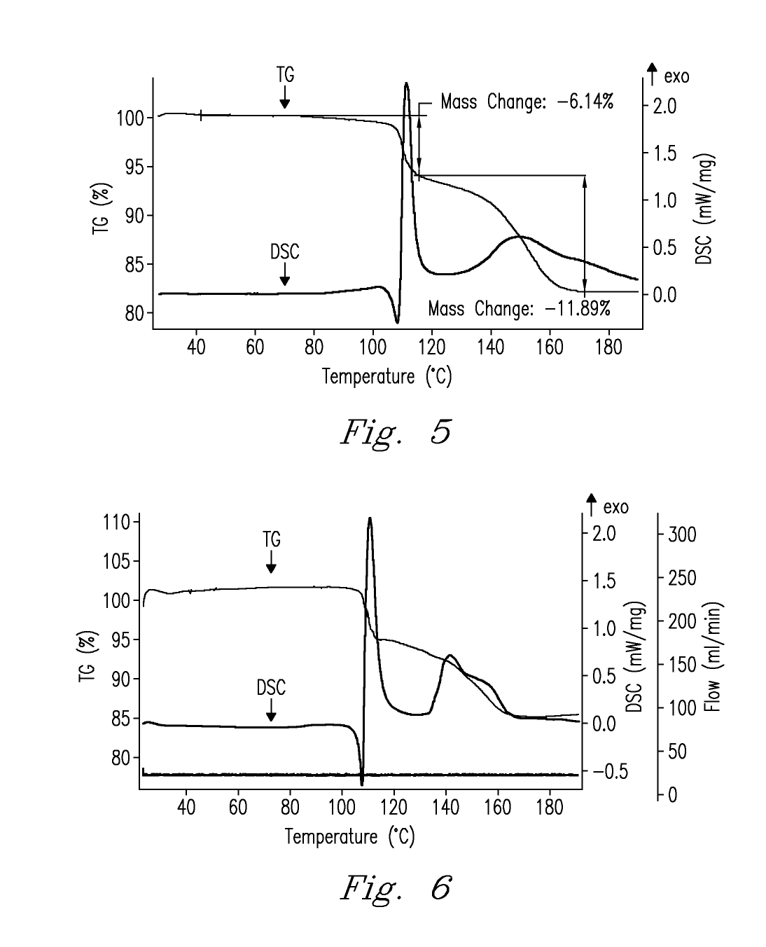

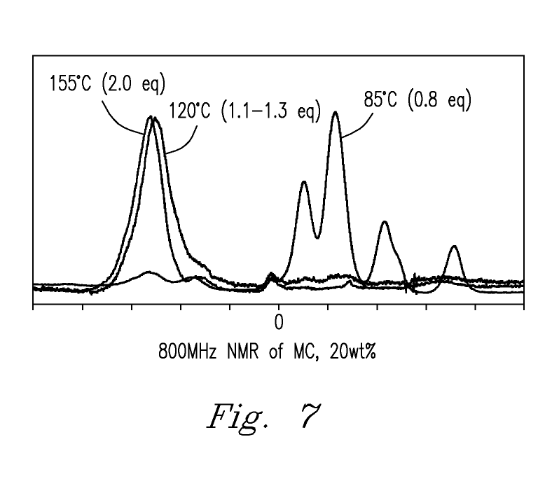

In an exemplary test, 80 wt % AB was mixed with 20 wt % methyl cellulose (MC) as described in Example 1. Hydrogen release from the composite was examined using DSC and Thermal Gravimetric (TG) analysis. Tests were used to show the degree of control and reproducible weight loss during dehydrogenation. Visual inspection of the residual material confirmed the degree or lack of foaming. FIG. 5 plots the TG and DSC results for the tested composite.

Results. In the TG plot, two (2) principal mass changes are observed. A first change in mass occurs in the temperature range from about 80° C. to about 120° C. of approximately 6.1%. A second change in mass occurs in the temperature range from about 120° C. to about 173° C. of approximately 11.9%. The mass change and temperature range for the dehydrogenation step is identical that those of native ammonia borane (AB), indicating that this additive in this form does not alter hydrogen release behavior of the native (neat) bulk hydrogen storage and releasing material.

### Example 3

### Preparation of Sorbitol:AB Composite

### 30 wt %:70 wt %

In another exemplary test, 0.700 g of ammonia borane (AB) solid was dissolved in 5 mL of tetrahydrofuran (THF). 0.300 g of dry sorbitol powder (M_{w}=182) was added to the AB/THF solution. Sorbitol is sparingly soluble in THF. Mixture was well dispersed using a spatula to obtain a cloudy solution. The solvent (THF) was then evaporated from the pasty mixture to obtain a dry powder. The composite material contained 30% sorbitol and 70% ammonia borane (AB) by weight (wt %).

### Example 4

### Preparation of PHMS:AB Composite

### 10 wt %:90 wt %

In another exemplary test, 0.900 grams of ammonia borane (AB) solid was dissolved in 5 mL of tetrahydrofuran (THF). 0.100 grams of polymethylhydrosiloxane (PHMS) was added to the AB/THF solution. Mixture was well dispersed using a spatula to obtain a smooth pasty mixture. Solvent (THF) was evaporated from the pasty mixture to obtain a dry powder. The composite material contained 10% polymethylhydrosiloxane (PHMS) and 90% ammonia borane (AB) by weight (wt %).

### Example 5

### DSC/TG tests

### PHMS:AB Composite

### 10 wt %:90 wt %

In an exemplary test, the composite comprising 10 wt % PMHS foam control reagent and 90 wt % AB 3 was tested using DSC and Thermal Gravimetric (TG) analysis. These tests also show the degree of control and reproducible weight loss upon dehydrogenation. Visual inspection of the residual material confirmed the lack of foaming. FIG. 6 plots the TG and DSC results for the tested composite.

Results. Results provide a baseline by which to compare results for the composite to those of the neat hydrogen releasing material, ammonia borane, both in terms of thermodynamics and hydrogen releasing behavior. Additionally these instruments provide a controlled way of heating the sample in suitable atmosphere. Again, mass change and temperature range for the dehydrogenation step is identical that those of native ammonia borane (AB), indicating that this additive in this form does not alter hydrogen release behavior of the native (neat) hydrogen storage and releasing material.

### Example 6

### DSC/TG tests

### PHMS:AB Composite

### 20 wt %:80 wt %

In an exemplary test, a composite comprising 20 wt % PMHS foam control reagent and 80 wt % AB prepared as in Example 1 was tested using DSC and Thermal Gravimetric (TG) analysis. These tests also show the degree of control and reproducible weight loss upon dehydrogenation. Visual inspection of the residual material (i.e., following hydrogen release) showed foaming was contained to below about 1% compared to the neat material.

### Example 7

### Preparation of MC:AB Composite

### 15 wt %:85 wt %

In another exemplary test, 0.850 grams of ammonia borane (AB) was dissolved in 2 mL of water. 0.150 g of dry methyl cellulose powder (Mₙ=86000) was added to the AB/Water solution. Mixture was well dispersed using a spatula to obtain a clear solution. Solvent (water) was evaporated from the solution to obtain a dry powder. The material was held under vacuum conditions to ensure complete removal of the solvent. The composite material contained 15% methyl cellulose and 85% AB by weight (wt %).

### Example 8

### Preparation of MC:AB Composite

### 20 wt %:80 wt %

### Slurry

In another exemplary test, 0.800 g of ammonia borane (AB) was dispersed in 2 mL of toluene to form a slurry. 0.200 g of methyl cellulose (MC) (Mₙ=86000) as a dry powder was added to the AB/toluene slurry. The mixture was well dispersed using a spatula to obtain a smooth pasty mixture. The solvent (toluene) was evaporated from the pasty mixture to obtain a dry powder. The material was held under vacuum conditions to ensure complete removal of the solvent. The composite material contained 20% methyl cellulose and 80% AB by weight (wt %).

### Example 9

### Preparation of MC:AB Composite

### 10 wt %:90 wt %

### Slurry

In another exemplary test, 0.900 g of ammonia borane (AB) was dispersed in 2 mL of toluene to form a slurry. 0.100 g of methyl cellulose (Mₙ=17000) as a dry powder was added to the AB/toluene slurry. The mixture was well dispersed using a spatula to obtain a smooth pasty mixture. In this example, solvent was not removed to show that the slurry form could be maintained. The composite material in the slurry contained 10% methyl cellulose and 90% AB, which was maintained in toluene.

### Example 10

### Preparation of MC:AB Composite

### 15 wt %:85 wt %

### Slurry

In another exemplary test, 0.150 g of methyl cellulose (Mₙ=17000) dry powder was dispersed in 2 mL of tetrahydrofuran (THF) to form a slurry. 0.850 g of ammonia borane (AB) added to the methyl cellulose/THF slurry, which dissolved in the solvent. The mixture was well dispersed using a spatula to obtain a smooth pasty mixture. The composite material in the slurry contained 15% methyl cellulose and 85% AB, which was maintained in THF.

### Example 11

### Characterization of Spent (MC:AB) Composites

In an exemplary test, composites comprising 80 wt % AB mixed with 20 wt % methyl cellulose (MC) as a foam suppression agent were characterized by NMR following release of hydrogen at selected temperatures. FIG. 6 presents NMR results showing peaks for the spent composite following hydrogen release as a function of temperature.

Results. In the figure, at a temperature beginning at about 85° C., peaks consistent with ammonia borane subjected to identical conditions are present. The largest quantities of hydrogen are released from the MC:AB:(20:80) composition in the temperature range from about 120° C. (1.1 to 1.3 equivalents) to about 155° C. (2.0 equivalents), respectively. Results confirm that products formed by dehydrogenation of AB are identical to products obtained from (methyl cellulose:AB) composites, meaning the MC additive does not change the chemistry of the hydrogen releasing material. MC prevents foaming.

### CONCLUSIONS

Results demonstrate that foaming in bulk hydrogen releasing materials can be controlled with suitable foam suppression reagents that yet meet weight restriction requirements for use in conjunction with next-generation fuel materials, energy devices, and applications. In addition, dimensions and footprints of composites including these bulk hydrogen releasing materials and foam suppression reagents can also be maintained.

We claim:

1. A composition that controls foaming in bulk hydrogen releasing materials, characterized by:
a preselected quantity of at least one foam suppression reagent; and
a preselected quantity of least one hydrogen releasing material;
said foam suppression reagent is dispersed in said at least one hydrogen releasing material or vice versa in a solid product that provides a preselected change tolerance upon release of hydrogen from said composite.

2. The composition of claim 1, wherein said at least one hydrogen releasing material includes ammonia borane.

3. The composition of claim 1, wherein said at least one hydrogen releasing material includes lithium borohydride.

4. The composition of claim 1, wherein said at least one hydrogen releasing material includes ammonia borane and lithium borohydride.

5. The composition of claim 1, wherein said at least one foam suppression reagent is selected from the group consisting of: methyl cellulose; polyhydromethylsiloxane; sorbitol, and combinations thereof.

6. The composition of claim 1, wherein said at least one foam suppression reagent includes a polymer selected from the group consisting of: celluloses; starches; siloxane polymers; polyvinylalcohols; polyvinylidenes; polypyrroles; polylactones; polycarbonates; polystyrenes; polysaccharides; and combinations thereof.

7. The composition of claim 1, wherein said at least one foam suppression reagent is selected from the group consisting of: starches; celluloses; cellobioses; lignocelluloses; and combinations thereof.

8. The composition of claim 1, wherein said at least one foam suppression reagent is selected from the group consisting of: polysaccharides; oligosaccharides; disaccharides; monosaccharides; and combinations thereof.

9. The composition of claim 1, wherein said at least one foam suppression reagent is selected from the group consisting of: siloxanes; polymethylsiloxanes; silanes; silicones; polyamino boranes; polyiminoboranes; and combinations thereof.

10. The composition of claim 1, wherein said at least one foam suppression reagent is selected from the group consisting of: methyl cellulose; alkyl cellulose; acyl cellulose; xylitol; mannitol; and combinations thereof.

11. The composition of claim 1, wherein said at least one foam suppression reagent is an organic acid selected from the group consisting of: citric acids; lauric acids; malonic acids; stearic acids; and combinations thereof.

12. The composition of claim 1, wherein said at least one foam suppression reagent is selected from the group consisting of: glycols; ureas; dextrins; sorbitols; and combinations thereof.

13. The composition of claim 1, wherein said preselected quantity of said at least one foam suppression reagent is selected in the range from about 1 wt % to about 50 wt %.

14. The composition of claim 1, wherein said preselected quantity of said at least one foam suppression reagent is selected in the range from about 5 wt % to about 50 wt %.

15. The composition of claim 1, wherein said preselected quantity of said at least one foam suppression reagent is selected in the range from about 10 wt % to about 30 wt %.

16. The composition of claim 1, wherein said solid product includes a structured form selected from the group consisting of: wafers, discs, tapes, monoliths, buttons, and combinations thereof.

17. The composition of claim 1, wherein said solid product includes a structured form selected from the group consisting of: pellets, spheres, beads, particles, and combinations thereof.

18. The composition of claim 1, wherein said solid product is dispersed as a slurry in a selected solvent.

19. The composition of claim 1, wherein said solid includes a change tolerance selected in the range from about 0% to about 25% by volume.

20. The composition of claim 1, wherein said solid includes a change tolerance selected in the range from about 0% to about 100% by volume.

21. A method for preparing a composite comprising at least one hydrogen releasing material and at least one foam suppression reagent, characterized by the steps of:
dissolving a preselected quantity of said at least one hydrogen releasing material in a preselected solvent to form a solution; and
dispersing a preselected quantity of said at least one foam suppression reagent therein to form a composite mixture, wherein said at least one foam suppression reagent is dispersed in said at least one hydrogen releasing material or vice versa in said composite mixture.

22. The method of claim 21, wherein said composite mixture is a slurry.

23. The method of claim 21, wherein said composite mixture is a paste.

24. The method of claim 21, further including the step of removing said solvent from said product mixture to form a solid product.

25. The method of claim 24, wherein said solid product is a powder product.

26. The method of claim 24, further including the step of forming said solid product to yield a preselected shape for said product.

27. The method of claim 26, wherein said preselected shape of said solid product is selected from the group consisting of: wafers; discs; tapes; monoliths; pencils; buttons, and combinations thereof.

28. The method of claim 26, wherein said preselected shape of said solid is selected from the group consisting of: pellets, spheres, beads, particles, and combinations thereof.

29. The method of claim 26, wherein the step of forming said preselected shape includes a method selected from the group consisting of: pressing, pelletizing, casting, extruding, mixing, coating, stirring, drying, and combinations thereof.

30. The method of claim 21, wherein solid product has a change tolerance selected in the range from about 0% to about 25% by volume upon release of hydrogen therefrom.

31. The method of claim 21, wherein solid product has a change tolerance selected in the range from about 0% to about 100% by volume upon release of hydrogen therefrom.

32. A method for preparing a composite comprising at least one hydrogen releasing material and at least one foam suppression reagent, comprising the steps of:
mixing a preselected quantity of said at least one foam suppression reagent in a solvent to form a slurry; and
dispersing a preselected quantity of said at least one hydrogen releasing material in said slurry, forming a composite mixture;
wherein said at least one foam suppression reagent is dispersed in said at least one hydrogen releasing material or vice versa in said composite mixture.
